(19) United States
(12) Patent Application Publication
(10) Pub. No.: US 2004/0184905 A1
(43) Pub. Date: Sep. 23, 2004

(54) Agricultural grain wagon

(75) Inventors: Jon E. Kinzenbaw, Williamsburg, IA (US); Alan F. Barry, Fairfax, IA (US); Dan L. Garland, Iowa City, IA (US); Lisle J. Dunham, Grinnell, IA (US)

Correspondence Address: James J. Hill, Emrich & Dithmar, Ste. 3000, 300 South Wacker Drive, Chicago, IL, 60606, US

(73) Assignee: KINZE MANUFACTURING, INC. (Iowa Corporation), Williamsburg, IA

(21) Appl. No.: 10/766,109

(22) Filed: Jan. 27, 2004

Related U.S. Application Data
(60) Provisional application No. 60/446,813, filed on Feb. 12, 2003.

(51) Int. Cl. B60P 1/00

(52) U.S. Cl. 414/526

(57) ABSTRACT

An agricultural grain wagon includes a one-piece floor auger which may be removed as a unit from the rear of the wagon for servicing. A clean-out pan is slidably mounted beneath the floor auger and a lower tough forming the bottom of the hopper. The clean-out pan may be reciprocated beneath the floor auger to clean out any residual grain beneath the hopper. The wagon also includes a forward two-piece unload auger having an upper section which may be positioned to a field fold position using an auger stand, thus reducing the time to place the unload auger in the discharge position and providing an extended reach of the unloaded auger to facilitate unloading.

### RELATED APPLICATION

This application claims the benefit of U.S. Provisional Application No. 60/446,813 filed on Feb. 12, 2003 for “AGRICULTURAL GRAIN WAGON”.

### FIELD OF THE INVENTION

The present invention relates to improvements in agricultural grain wagons. In particular, the invention relates to large agricultural grain wagons of the type having a generally horizontal floor auger located at the bottom of the hopper for moving grain in the hopper to the front, and an articulated unload auger mounted to the front of the wagon. The unload auger receives grain from the floor auger and moves it upwardly and to the side for unloading, either into a moving transport truck, a stopped truck for further transport or a storage area.

### BACKGROUND

Large grain wagons of the type with which the present invention is concerned have been known for some time, particularly agricultural grain wagons having a floor auger and an articulated unload auger.

However, certain problems have been inherent in previous designs. One of the problems with prior art designs is that due to the structure and location of the floor auger (depending on the size of the wagon, a floor auger may be eighteen to twenty-four feet long), it has been difficult to access the auger for maintenance and clean out. Auger flights, bearings and drive systems may require maintenance, but in the past, it was difficult to access the auger because the auger has been semi-permanently mounted inside the wagon during manufacturing, thus requiring torching of the original materials for auger access.

Moreover, because the floor auger is at the bottom of the hopper, which typically is formed by a trough shaped to the outer diameter of the auger flights but spaced from the auger flights in order to provide clearance for movement of the auger, it is difficult to access the area beneath the auger for cleaning out residual grain after the grain wagon has been emptied. Making it even more difficult to access the recess beneath the floor auger is the fact that the floor auger of past machines was made of separate forward and rear auger sections joined together by a hanger bearing which also supported the junction of the two auger sections and was mounted to the trough beneath the auger.

More recently, the requirement for complete wagon clean out has become more important because some states have enacted requirements on the interstate transport of feed grains. Specifically, some states prohibit the importation of some genetically engineered hybrid grains. This requires that the wagon be cleaned out of residual grain before harvesting non-prohibited grain for transportation into states having such a requirement.

As noted above, however, it is difficult to access the area beneath the auger, particularly with the hanger bearing arrangement mentioned above supporting the juncture of the forward and rear augers and located in the recess beneath the auger. The grain clean out requirement has led to workers' descending into the wagon with air blowers and the like, and suction machines for displacing the grain beneath the auger under pressurized air and then recovering the grain. This is a time-consuming, tedious and imperfect method of total clean out. The worker has no direct vision of the entire area to be cleaned out.

Another area which is desired to be improved is the operation of the forward articulated vertical auger or unload auger as it is sometimes referred to. The unload auger may be a two-section auger which receives the grain from the floor auger which is inside the hopper. The unload auger is located in front of the hopper. When the unload auger is in the use or unload position, the grain is carried by the unload auger upwardly and laterally where it may be deposited, for example, in a truck or a transporting wagon.

When the wagon is being used to unload a combine in field operation, the cycle of extending the unload auger to the unload position from the transport or fully fold position is required to be completed periodically in order to unload the wagon. That is, a transport truck may be filled by the unload auger and then move off to take its grain to a grain elevator or other storage elevator. Later, after further harvest, a second truck may pull up alongside the grain wagon for unloading in order to sustain operation of the combine. Between unloading cycles, the unload auger of prior designs is desirably placed into the fold or transport position in order to reduce the forward profile of the grain wagon and thereby increase safety and avoid any unnecessary collisions. However, it takes time to reposition the unload auger between the transport position and the unload position. Further, in order to prevent the rear tractor tires from scraping against the unload auger during sharp turns in the transport position, the unload auger had to be shorter than is possible with the present invention.

### SUMMARY OF THE INVENTION

The present invention provides a one-piece floor auger in an agricultural grain wagon which may be removed as a unit and is supported only at its forward and rear ends, so that it does not require any intermediate support. The floor auger tube is mounted at the forward and rear ends by means of hub assemblies which include spindles and tapered roller bearings. The front spindle is driven, and it includes drive members having drive dowels which are received in a slug having apertures for receiving the drive dowels. The slug is welded inside the front of the hollow auger tube on which the auger flights are welded. The rear auger mount is an idler.

The rear hub assembly is bolted to a removable cover plate mounted to a rear mounting plate of the frame of the wagon. By removing the floor auger rear cover plate, access is gained to the rear hub assembly, and the entire auger may be removed rearwardly, in an axial direction of the auger through a suitable access aperture in the rear mounting plate. In other words, the rear idler hub assembly is mounted to the rear cover plate so that when the cover plate is removed (with the auger temporarily supported), the rear hub assembly is free from the auger and may be removed, and the rear of the auger is free. Further, the front of the auger may be moved axially rearwardly to disconnect it from the forward drive hub assembly. Thus, the auger may be accessed in its entirety, and maintenance, repair or inspection is facilitated on either the front hub assembly, the rear hub assembly, the auger itself, or the trough located beneath the auger.

When the floor auger is assembled to the frame of the wagon, there is clearance between a formed trough located at the bottom of the hopper of the wagon and the floor auger itself. This permits the floor auger to rotate and move grain stored in the hopper from the rear toward the front for discharge without having the auger flights scrape against or engage any portion of the trough.

Grain, however, may collect in the bottom of the trough, in the recess between the trough and the auger. The present invention provides a clean-out pan located in the recess between the trough and the auger, and conforming to the shape of that recess. The clean-out pan, when not in use, is stored and fixed at the rear of the frame adjacent the rear auger cover plate. An elongated rod may be threaded into the pan by the operator for cleaning the recess beneath the auger. An opening (called the clean-out port) is located at the bottom of the trough near the rear and beneath the storage position of the clean-out pan. By removing an access panel beneath the clean-out port, grain is free to fall out of the recess beneath the auger at the rear of the trough. By pushing the clean-out pan forwardly with the rod, grain in the recess beneath the auger is moved forwardly and pushed into the base or inlet of the unload auger where it is easily accessed. The clean-out pan is then manually reciprocated toward the rear of the wagon and residual grain is discharged through the rear clean-out port. Any residual grain may be easily removed by one or more cycles of moving the clean-out pan back-and-forth in the recess beneath the auger using the long rod.

Another improvement of the present invention concerns the unload auger located at the front of the wagon and supported by the frame of the wagon and the wagon hitch. The unload auger is intended to discharge grain from within the hopper moved forwardly by the floor auger. The unload auger is articulated so that the upper section may be rotated to a fully folded position in which the wagon is prepared for transport or storage. When the unload auger is folded to the transport position, the profile of the auger is within the front profile of the wagon so that the unload auger extends substantially within the wagon profile on either side, above or below. However, care must be taken to avoid having the rear tractor tires scrape the unload auger when folded for transport, particularly during sharp turns.

Thus, the present invention provides an intermediate or field fold position for the unload auger using a manually adjustable auger stand which is hinged between a storage position and a field position. In the field fold position, the auger stand supports the upper auger section in a generally lateral disposition, that is, with the upper auger section not in a completely folded shipping position, but well clear of the rear tractor tires.

This has two advantages. The first advantage is that it takes less time to cycle the unload auger into the discharge position with the two auger sections axially aligned and ready for discharging the contents of the wagon. Second, by supporting the upper auger section in an intermediate or field fold position, it is possible to increase the length of unload auger in the discharge position while avoiding interference with the tractor tires so that the discharge head of the unload auger is located further laterally to the side of the wagon thereby permitting more leeway between the wagon and a truck adjacent the wagon.

Other features and advantages of the present invention would be apparent to persons skilled in the art from the following detailed description of a preferred embodiment accompanied by the attached drawing wherein identical reference numerals will refer to like parts in the various views.

### BRIEF DESCRIPTION OF THE DRAWING

FIG. 1 is a left side view of an agricultural grain wagon incorporating the present invention;

FIG. 2 is a front elevational view of the wagon of FIG. 1;

FIG. 3 is a plan view of the wagon of FIG. 1 with a portion of a lower front panel broken away to show the forward position of the auger clean-out pan;

FIG. 4 is a perspective view taken from an upper, rear and left side of the wagon showing the improved construction for the floor auger and the forward unload auger;

FIG. 5 is a plan view of the improvements to the auger with the center portion of the auger broken away and the forward and rear plates of the hopper in fragmentary form;

FIG. 6 is a vertical cross-sectional left side view of the forward drive hub assembly;

FIG. 7 is a front view of the drive hub assembly of FIG. 6;

FIG. 8 is a vertical cross-sectional left side view of the rear idler hub assembly;

FIG. 9 is a front view of the idler assembly of FIG. 8;

FIG. 10 is an upper, left, rear perspective view of the rear of the floor auger and welded frame with the side panels of the hopper removed and the rear cover plate and lower clean out slide in exploded relation;

FIG. 11 is a lower, rear left perspective view of the apparatus of FIG. 10, with the rear cover plate and clean out slide in exploded relation;

FIG. 11A is a rear view of the rear mounting plate and auger, with the rear cover plate removed;

FIG. 12 is a left side view of the grain wagon of FIG. 1 with the unload auger in the field fold position;

FIG. 13 is a front elevational view of the wagon as seen in FIG. 12;

FIG. 14 is a left side elevational view of the wagon of FIG. 1 with the unload auger in the discharge position;

FIG. 15 is a front elevational view of the apparatus of FIG. 14;

FIG. 16 is a perspective view, taken from a lower, frontal position of the unload auger in the discharge position.

FIG. 17 is a view of the unload auger taken from a view similar to that of FIG. 16 with the unload auger in the field fold position;

FIG. 18 is a perspective view of the unload auger stand arranged in the field fold position; and

FIG. 19 is a view of the auger stand taken from a perspective similar to that of FIG. 18, with the stand in the fully folded or transport position.

### DETAILED DESCRIPTION OF THE ILLUSTRATED EMBODIMENT

Referring first to FIG. 1, reference numeral 10 generally designates an agricultural grain wagon incorporating the present inventions. The wagon 10 includes a welded frame generally designated 12. Referring to FIGS. 1, 3 and 4, the welded frame 12 includes a hitch 13, a front mounting plate 31, a formed trough 15, and a rear mounting plate 23, all welded into a rigid frame. The frame 12 is supported by ground engaging wheels 17 mounted on a conventional axle. Alternatively, the wagon may be supported by a pair of continuous belted tracks, as is known in the industry.

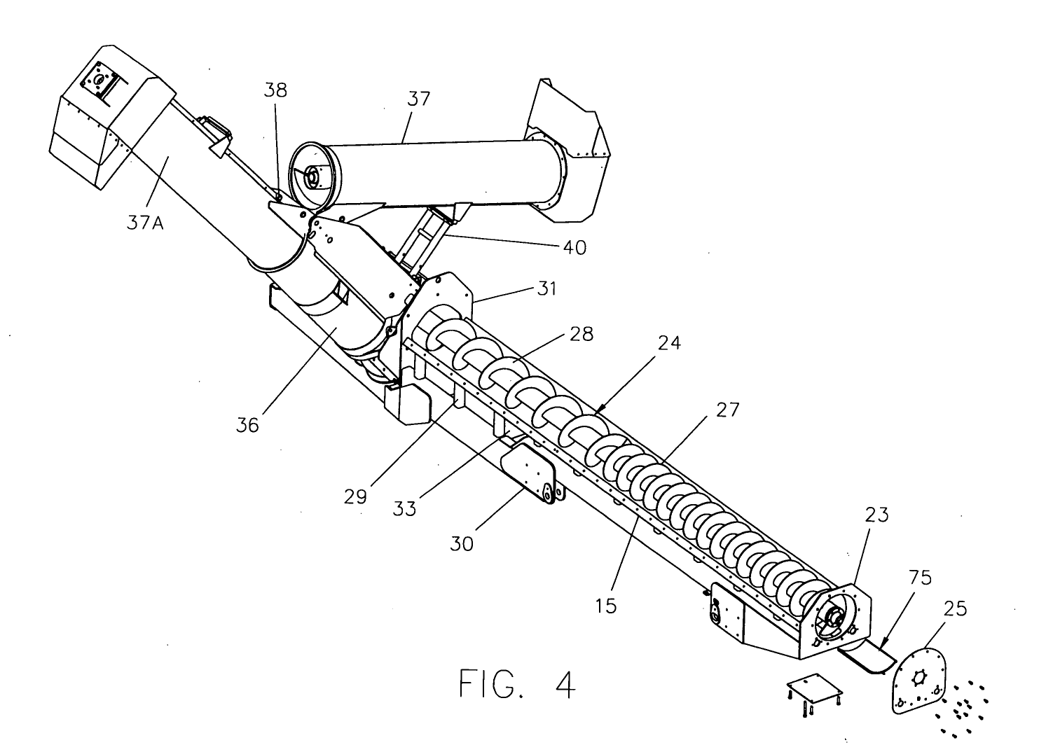

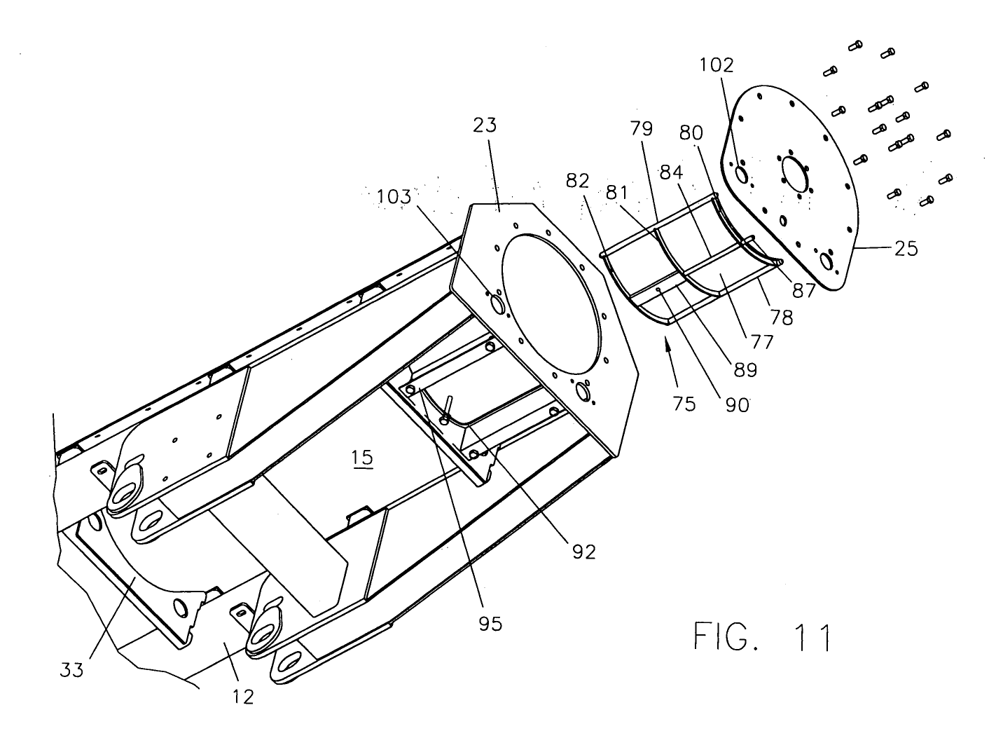

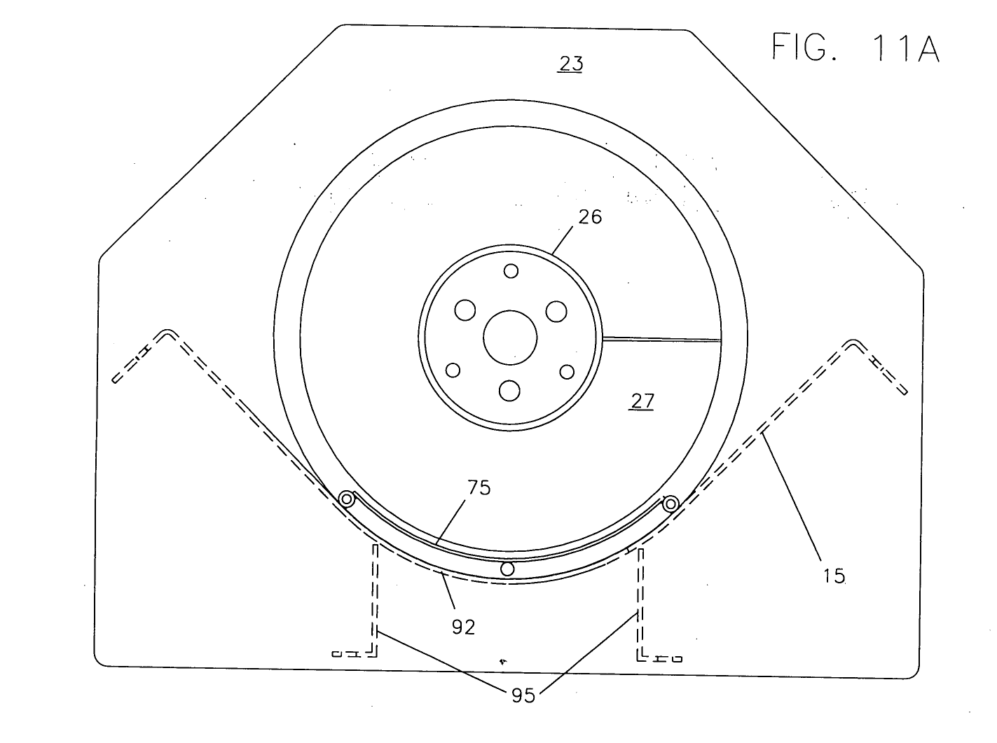

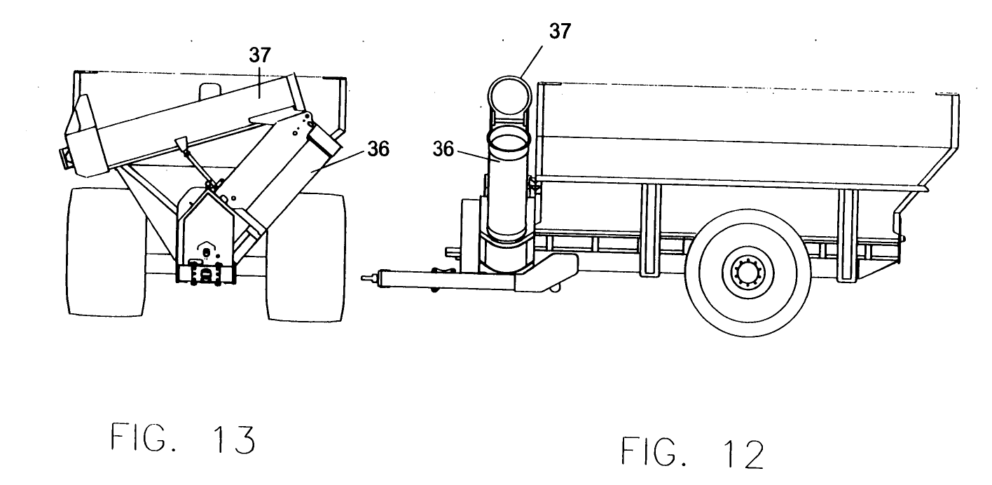

The welded frame 12 extends to the rear of the trough 15, as seen in FIGS. 4 and 11, and it includes a rear mounting plate 23, which supports the floor auger, as will be further described. The frame 12 also supports the panels of a hopper generally designated 18 (FIG. 1), including side panels 19, 20, as well as a front panel 21 and a rear enclosure paneling 22. All of the paneling may be conventionally fabricated of sheet metal.

Referring particularly to FIG. 4, the paneling of the hopper is removed to show a one-piece floor auger generally designated 24 mounted, as will be described, and completely suspended entirely by a front mounting plate 31 welded to the frame 12, and the rear mounting plate 23, also part of the frame 12. The auger 24 is located above, and slightly spaced from the trough 15 to form a clearance recess. The trough 15 conforms to the external shape of the flights of the auger 24, but it is necessary to space the trough from the auger in order to provide for manufacturing tolerances and, as mentioned, to insure that under all conditions of use, the auger flights do not strike the trough 15.

As is conventional, the floor auger 24 may include a rear flighting section 27 and a forward flighting section 28. The rear flighting section 27 may preferably have a smaller pitch than the forward flighting section 28 so that the two flighting sections cooperate to more evenly distribute the weight of the grain held in the hopper during unloading, as is known. However, according to the present invention, both flighting sections are welded to a single, integral continuous auger tube 26. The advantages of this one-piece, integral structure will be made apparent.

Referring particularly to FIG. 4, the trough 15 is supported by a series of vertical riser tubes 29 extending between a sub-frame 30 and a flange of the trough 15. The sub-frame 30 is welded to the previously described welded frame 12. A series of spaced cradles 33 (see FIG. 11 also) are also welded between the frame 12 and the formed trough 15 for additional support and rigidity of the formed trough 15.

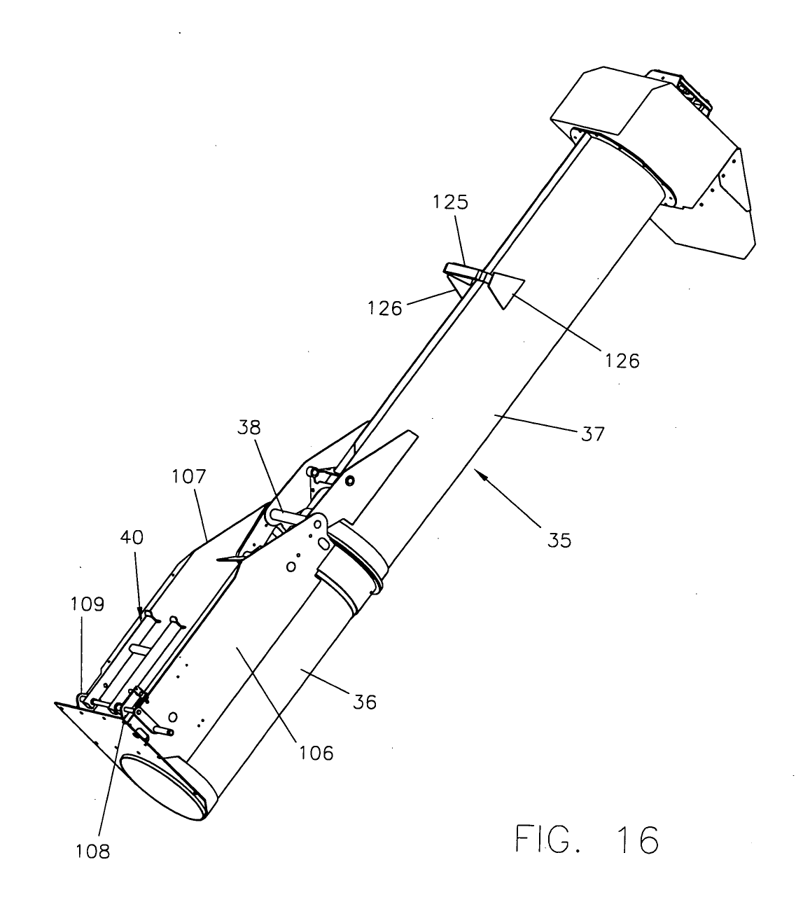

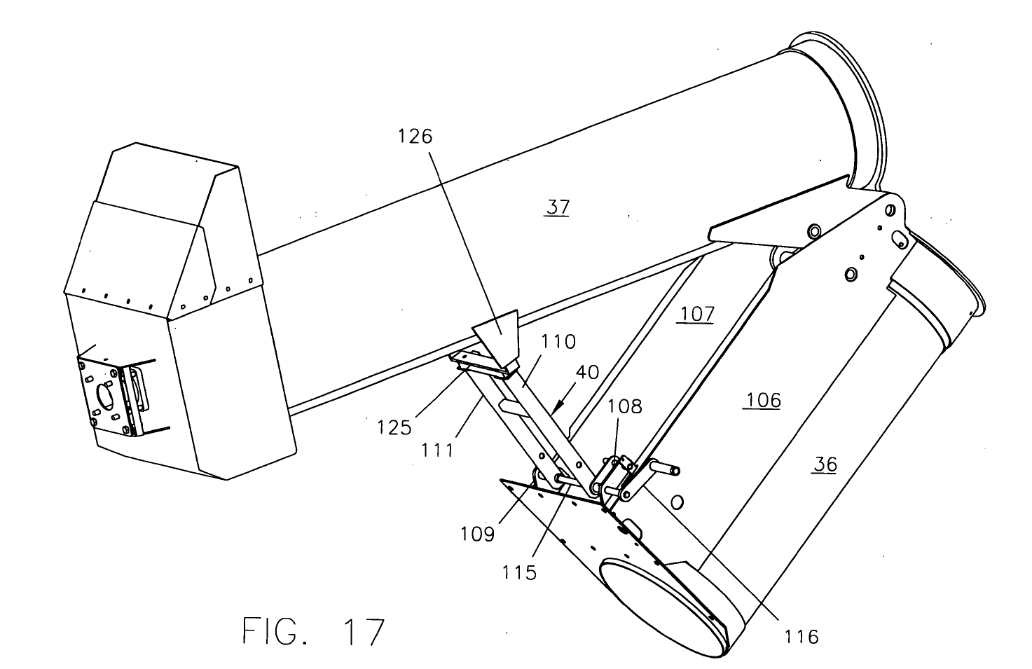

Before proceeding to further details of the inventions, persons skilled in the art will appreciate that the floor auger 24 extends horizontally. The floor auger 24 delivers grain from the hopper 18 forwardly through the forward mounting plate 31 to the base of an unload auger generally designated 35 in FIG. 16 and sometimes referred to as the “vertical” auger or “discharge” auger. The unload auger 35 is articulated in that it includes a lower auger section 36 rigidly mounted to the front auger mounting plate and supported by the frame 12, and an upper auger section 37 which is hinged to the lower auger section 36 by a pin 38 (FIG. 4). The upper auger section 37 may be moved between one of three different positions, as will be further described below.

Referring to FIG. 4, when the upper auger section 37 is axially aligned with the lower auger section 36 as seen at 37A in FIG. 4, the wagon is ready to unload the grain from the hopper, and this is referred to as the unload or discharge position. When the position of the upper auger section 37 is as seen at 37 in FIG. 4, supported by a field auger stand 40, the upper auger section is in an intermediate or field fold position, supported by the stand 40.

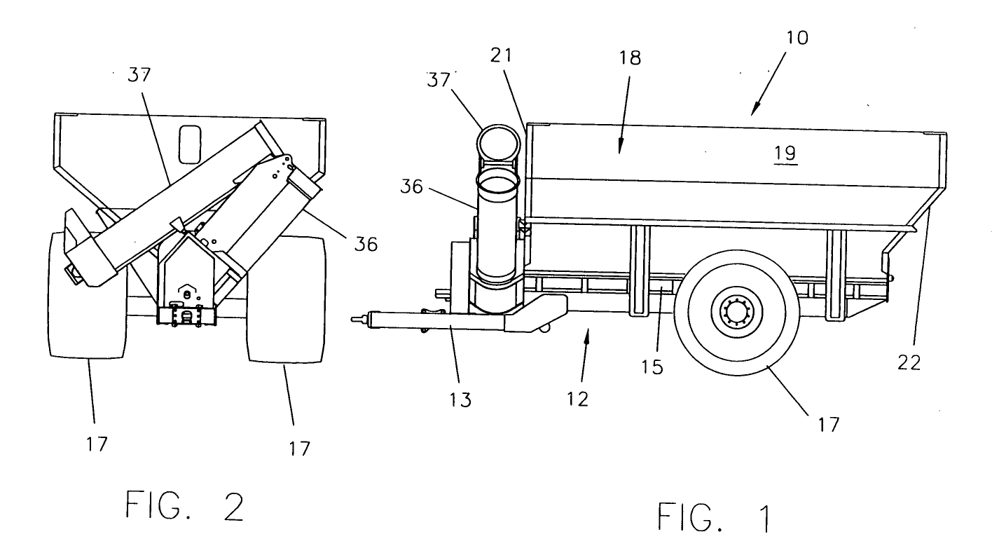

When the stand 40 is folded completely to the transport or storage position, as seen in FIGS. 1 and 2, the upper auger section 37 is completely folded and rests on the lower auger section.

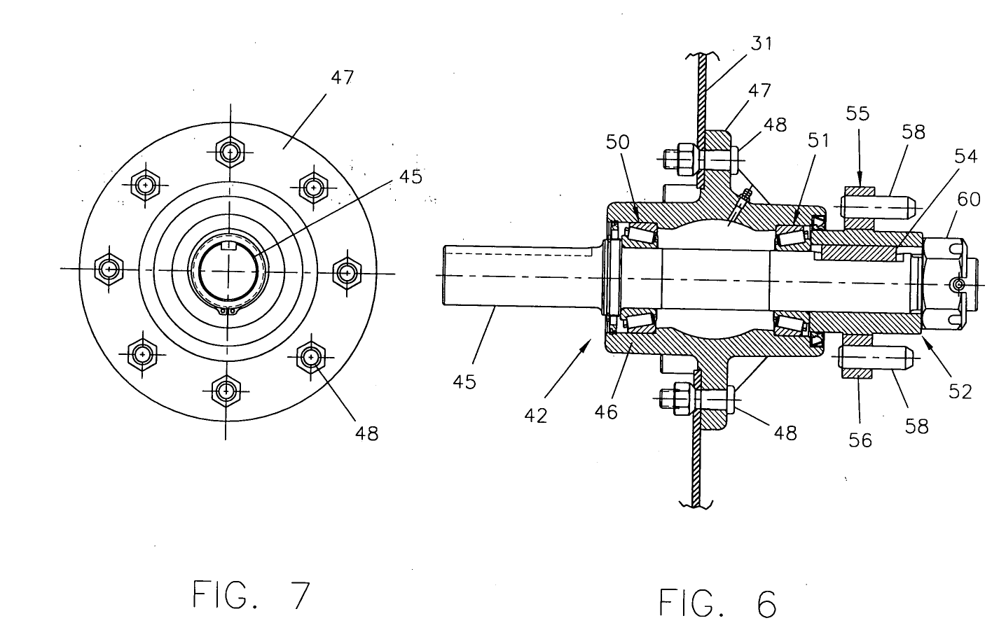

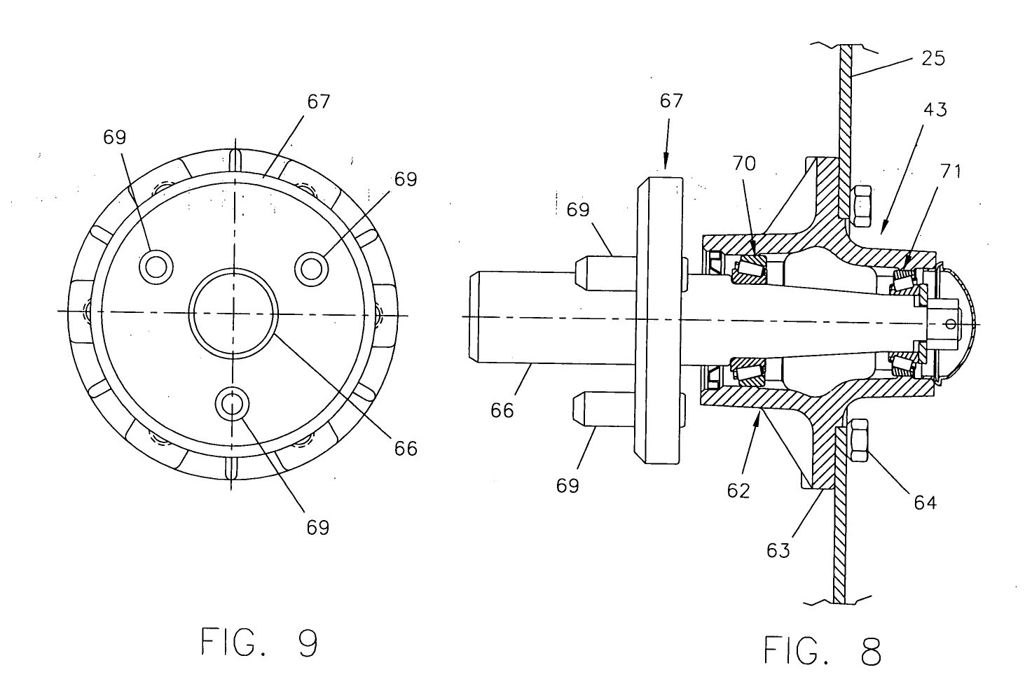

Turning now to FIGS. 4-9, the floor auger 24 is supported at its forward end by a front hub assembly generally designated 42 mounted to the front mounting plate 31 and at its rear end by a rear hub assembly generally designated 43 which, in turn, is mounted to the rear cover plate 25.

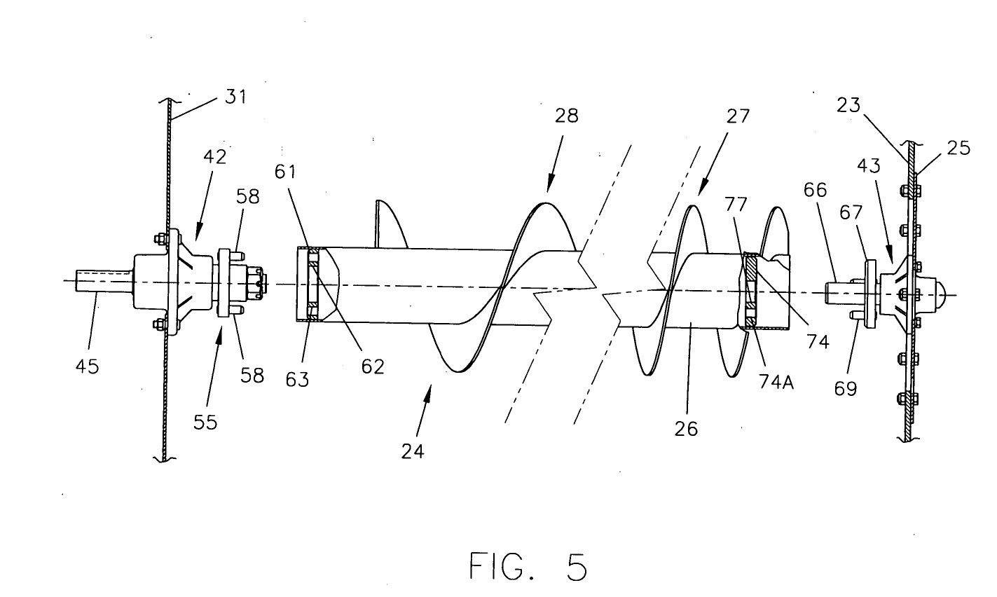

Referring now particularly to FIGS. 5-7, the front hub assembly 42 includes a drive shaft or spindle 45 which is keyed to a shaft powered by the power take-off of the tractor (not seen) and extends through a housing 46 which has a peripheral mounting flange 47 for mounting the casing by means of bolts 48 to the front mounting panel 31 which, as mentioned, is part of the welded frame 12, as described above.

The hub 42 is provided with forward and rear bearing cups receiving respectively tapered roller bearings generally designated 50 and 51 which support the shaft 45 within the hub casing 46. The shaft 45 extends rearwardly beyond the casing 46 where it is connected to a drive member generally designated 55. A sleeve 52 is rigidly connected to the shaft 45 by a key 54. An annular drive member 56 is rigidly mounted to the sleeve 52 as shown, and four cylindrical drive dowels 58 are pressed into bores in the cylindrical member 56 at 90 degree angular spacings. A nut 60 retains the sleeve 52 on the drive shaft 45.

The drive dowels 58 of the front drive hub assembly are received in corresponding apertures in a drive slug or plate generally designated 61 in FIG. 5 which is welded about its periphery to the interior surface of the auger tube 26. The drive slug 61 includes a pilot hole 62 for receiving the drive shaft 45, nut 60 and the sleeve 52; and it also includes four bores 63 which are aligned with and receive the drive dowels 58 of the drive member 55.

Turning now to FIGS. 5, 8 and 9, the rear or idler hub assembly 43 is similar to the front hub assembly 42. Identical parts need not be described in great detail. The rear hub assembly includes a hub casing 62 which includes a mounting flange 63 mounted by bolts 64 to the rear cover plate 25.

A spindle or shaft 66 has an annular shaped flange member 67 secured to it. Three driven dowels 69 are secured to the flange 67. The rear end of the shaft 66 is mounted by forward and rear tapered roller bearings 70, 71 to suitable cups formed in the casing 62 of the rear or idler hub assembly.

The rear of the auger tube 26, as seen in FIG. 5 contains a second drive slug 74 which is provided with three apertures 74A for receiving the three drive dowels 69 of the rear hub assembly. The rear drive slug 74 also includes a pilot aperture 77 for receiving the shaft 66 of the rear hub assembly.

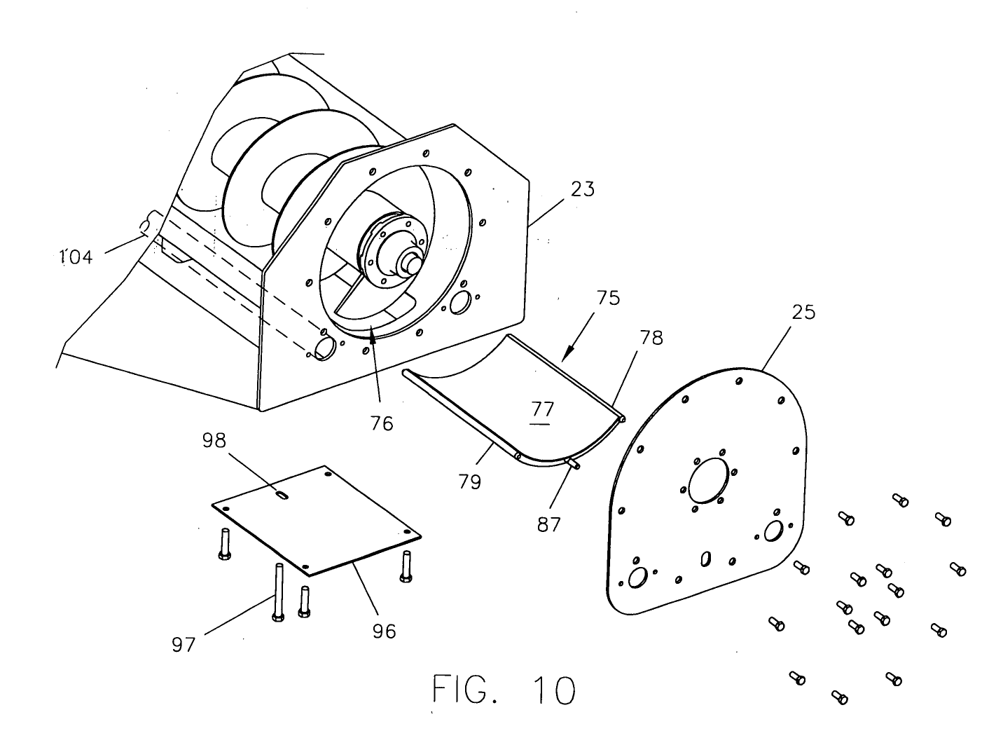

It will thus be appreciated that the entire one-piece floor auger 24 is mounted only at its front end by means of the front hub assembly 42 and its rear end by means of the rear hub assembly 43 and that there is no other mounting means for the auger. This enables manufacturing personnel to mount the auger by coupling the front drive slug 61 to the forward drive member 55; and then coupling the rear shaft 66 to the rear drive slug 74 while mounting the rear cover plate 25 to the rear mounting plate 23 of the auger frame 12, as seen in FIGS. 10 and 11.

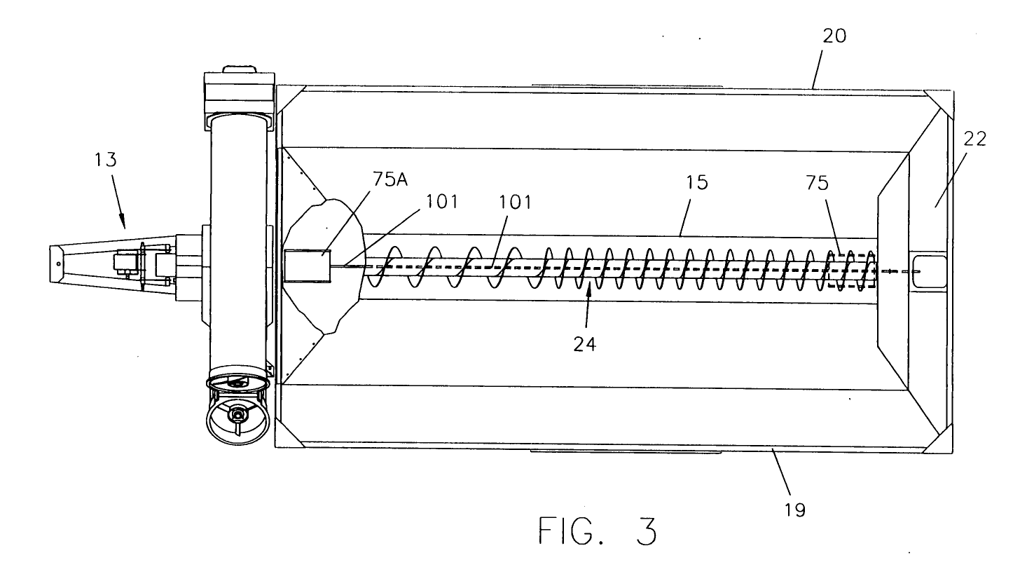

Turning now to FIGS. 3, 4, 10 and 11, a clean-out pan is generally designated 75. The clean-out pan 75 is shaped in a curvature corresponding to the outer circumference of the auger flights; and it is sized to fit in the recess between the outer circumference of the auger flights and the trough, this space or recess being designated by reference numeral 76 in FIG. 10.

Referring particularly to FIG. 11, the clean-out pan 75 includes an upper curved plate 77 made from sheet metal and having a radius of curvature slightly greater than the radius of curvature of the outer circumference of the auger flights. The clean out pan 75 includes first and second elongated side frame members 78, 79 and three curved braces or ribs including a rear rib 80, and intermediate rib 81, and a forward rib 82. All of the ribs 80, 81 and 82 are fixed to the side frame members 78, 79. A rod 84 is welded between the centers of the rib 81 and the rear rib 80, and it includes an internally threaded, rearwardly facing nipple 87 (see FIG. 10 also). The forward undersection of the clean-out pan 75 includes a rectangular bracing member 89 which includes an internally threaded aperture 90 for receiving a locking bolt, as will be described.

Referring now particularly to FIG. 11, a portion of the bottom of the trough 15 adjacent the access opening in the rear mounting plate 23 and slightly forwardly thereof, is cut away to form a rear clean-out port or discharge opening 92. The welded frame 12 includes bracing 95 (FIG. 11A) which extends around and frames the port 92. A discharge cover plate 96 (see FIG. 10) may be bolted into the bracing 95 of the rear clean-out port 92 so that in operation grain is not spilled on the ground through the opening 92. An elongated threaded fastener or bolt 97 is received in an aperture 98 of the discharge cover plate 96, and the threaded end of the bolt 97 is received in the internally threaded aperture 90 on the rectangular member 89 of the clean-out plate 75 to hold the clean-out plate, when it is not in use, in a rear position (see dashed line 75 in FIG. 3) to cover the port 92. It will be observed that the clean-out plate 75, by virtue of the two side frame members 78, 79 and the forward and rear ribs 80, 82 is sufficient to close the opening 92 and prevent most of the grain from falling between the curved panel 75 and the trough 15.

When it is desired to use the clean-out pan to clear the recess between the auger and the trough 15 from residual grain residing in the recess, the bolt 97 is removed from the aperture 90 of the clean-out pan to free the pan for movement; and the discharge cover plate 96 is removed from the lower framing 95.

An elongated rod (designated 101 in FIG. 3) has an externally threaded leading end, 101, which threadedly engages the rear nipple 87 of the clean-out pan, after freeing the clean-out pan 75. The rod 101 may then be urged by the operator in a forward, pushing movement. It will be appreciated that once the pan begins to move forwardly to uncover the clean-out port 92, grain will fall freely under gravity. A pan or other collector may be used to collect the grain which falls through the port 92. The clean-out pan 75 is then free to be moved forwardly, urging the residual grain to be displaced forwardly out the discharge end of the floor auger and into the input of the unload auger, where it may be more readily accessed. The pan 75 is seen in its forward position at 75A in FIG. 3. It may require a number of reciprocating movements of the clean out pan 75 to completely remove all residual grain from the recess beneath the auger, but the process may be completed quickly and without electrical power. The elongated rod 101 may be stored in a conduit 104 (FIG. 10) extending forwardly of an aperture 102 in the cover plate 25 which is aligned with the corresponding aperture 103 (FIG. 11) in the rear mounting plate 23. The conduit serving as a housing for the rod is designated 104.

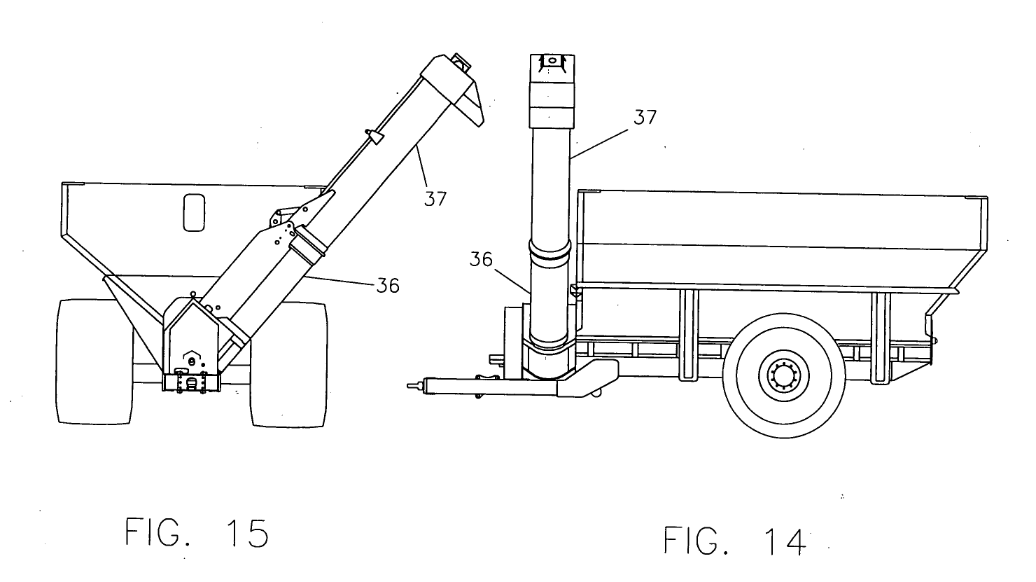

Turning now to FIGS. 14 and 15, and the improved unload auger, it is seen in the use position, with the lower tubular auger section 36 in axial alignment with the upper tubular auger section 37 and ready to discharge the contents of the wagon at a higher elevation at the top of the wagon at a location substantially removed from the side of the wagon, thereby permitting a truck to drive up along side the wagon to receive the grain.

Turning now to FIG. 16, the unload auger alone is seen, with the hinge pin 38 connected between the lower auger section 36 and the upper auger section 37. Conventionally, a hydraulic cylinder and linkage actuates the upper auger section 37 and actuates it between the unload position in FIGS. 14 and 15, and the transport position seen in FIGS. 1 and 2.

Still referring to FIG. 16, the field auger stand 40 is seen when the auger is set up in the transport or storage position. The auger stand 40 preferably remains in this position for transport and storage. In the storage position, the outer surface of the tube of the auger section 37 rests on two flanged plates 106, 107 which are welded to the lower auger section and which receive the hinge pin 38; and the auger is entirely within the front profile of the wagon.

The auger stand 40 is mounted to two brackets 108, 109 which are mounted to the upper edges respectively of the plates 106, 107 and at the lower or input end of the unload auger 36.

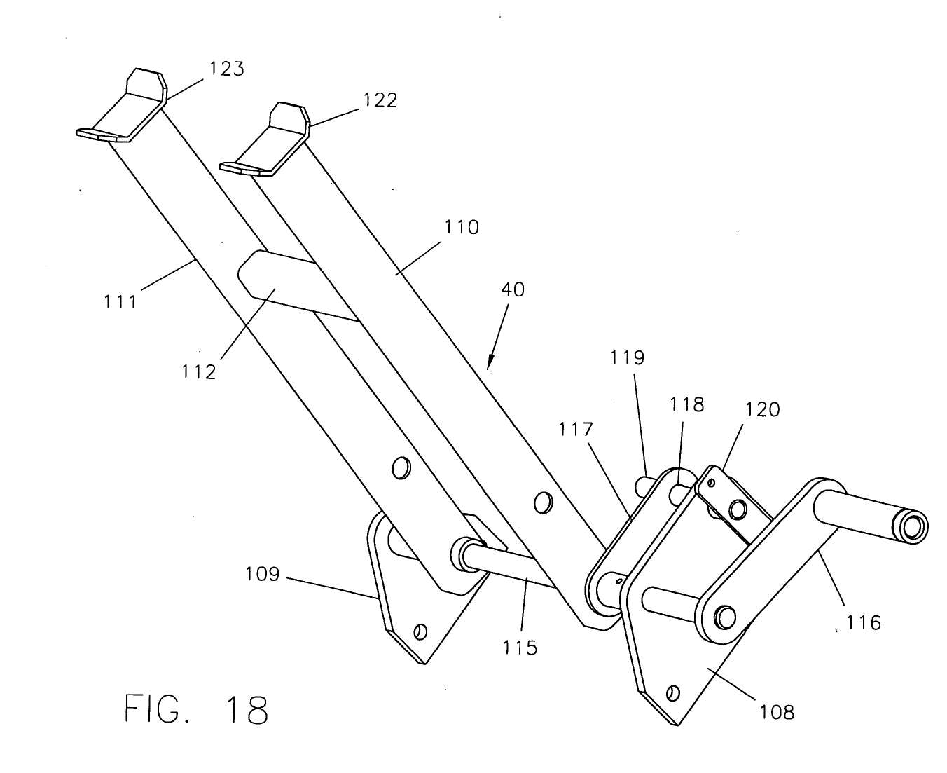

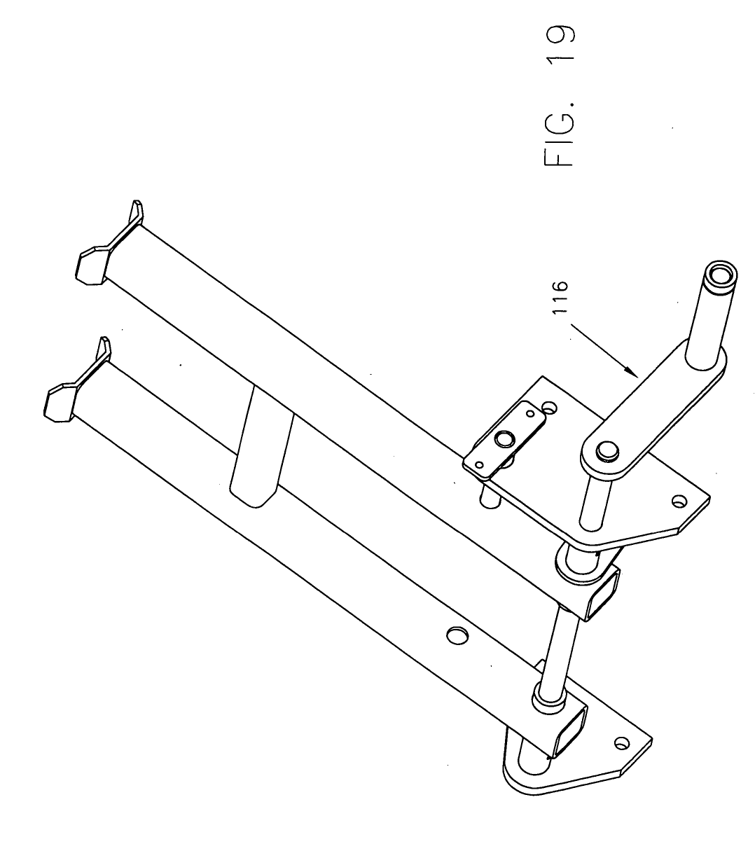

Turning now to FIGS. 17-19, the auger stand 40 includes first and second parallel, tubular legs 110, 111 which are secured together by means of a tubular cross bar 112 adjacent the distal ends of the legs 110, 111. The lower or proximal ends of the legs 110, 111 are attached to a shaft 115 which is journaled in the brackets 108, 109. The right end of the shaft 115 as seen in FIG. 18, extends through the mounting bracket 108 and is mounted to a crank handle 116.

A link 117 is fixed to the shaft 115 and includes an aperture 118 for receiving a pin 119 which is journaled in the plate 108 and provided with a handle 120. When the lock pin 119 is received in the aperture 118, the auger stand 40 is fixed in the raised position shown in FIGS. 17 and 18.

The distal ends of the tubular members 110, 111 are provided with support cradles 122, 123 which engage, receive and support a cross bar 125 which is mounted to the tube of the upper auger section 37 by means of brackets, one of which is seen at 126 in FIG. 17.

When the auger stand 40 is raised to the field ready position as seen in FIG. 17, it engages and supports the upper auger section 37 after folding from the upright discharge position. This enables the operator to reposition the upper auger section 37 to the discharge position seen in FIG. 16 by eliminating the time required to raise the upper auger section from the transport position seen in FIG. 2 to the discharge position seen in FIG. 15. It will also be observed from FIG. 13 that the discharge head of the upper auger section 37 is well above the right rear wheel of the tractor to avoid any interference between the two, even in sharp turns.

Having thus disclosed in detail an illustrated embodiment of the inventions, persons skilled in the art will be able to modify certain aspects of the structure which has been disclosed and to substitute equivalent elements for those described while continuing to practice the principal of the invention; and it is, therefore, intended that all such modifications and substitutions be covered as they are embraced within the spirit and scope of the appended claims.

We claim:

1. An agricultural grain wagon comprising:
a frame;
a hopper mounted to said frame;
ground engaging transport means supporting said frame;
a trough at the bottom of said hopper extending in the direction of travel of said wagon;
an auger having flighting received in said trough for rotation about an axis;
said flighting spaced from said trough to define a curved recess;
forward and rear hubs mounting said auger to said hopper; and
a clean out pan received in said curved recess and generally conforming to the shape thereof for reciprocal movement in said recess parallel to said axis of said auger for clearing residual grain in said recess.

2. The wagon of claim 1 further comprising:
an unload auger mounted to said frame in front of said hopper and receiving grain from the front of said first-named auger, said trough defining a discharge opening adjacent the rear of said auger; and
a cover removably secured to said hopper to close said discharge opening,
whereby as said clean out pan is moved toward the front of said auger, residual grain in said recess is urged forwardly to said unload auger, and as said clean out pan is moved rearwardly, residual grain is moved toward said discharge opening.

3. The wagon of claim 2 further comprising an elongated rod having a portion adapted to fasten to said clean out pan and to be removed therefrom for storage when not in use.

4. The wagon of claim 3 wherein said hopper defines an elongated recess for storing said rod when not in use.

5. The machine of claim 2 wherein said unload auger includes:
a lower section mounted to said frame;
an upper section pivotally mounted adjacent the top of said lower section for positioning between a transport position and an unload position; and
a stand pivotally mounted to one of said lower and upper unload auger sections and moveable to a position to prevent complete folding of said upper section, thereby to allow said upper section to reside in a partially folded position to reduce the time to return to the unload position.

6. The wagon of claim 1 characterized in that said auger is mounted only at its front and rear and said curved recess is unobstructed for reciprocal motion of said clean out pan between the front and rear of said auger.

7. The wagon of claim 1 wherein said front hub includes a drive member having a plurality of drive dowels extending axially of said auger, and wherein said auger includes a tube carrying said flighting, and a plate fixed adjacent the front of said auger tube and defining bores for receiving the dowels of said drive member.

8. The wagon of claim 7 wherein said rear hub supporting said auger is mounted to a removable panel fastened to said hopper, whereby when said panel is removed, said auger may be removed through an opening covered by said panel.

9. The wagon of claim 8 wherein said rear hub includes:
an idler shaft mounted by forward and rear tapered roller bearings, said shaft being tapered at the rear;
flange mounted to said shaft and including a plurality of pins extending forwardly;
said auger tube including an apertured plate fixed adjacent the rear thereof receiving said pins of said flange.

10. The wagon of claim 9 wherein said shaft of said forward hub is mounted by forward and rear tapered roller bearings.

11. An agricultural grain wagon comprising:
a frame;
a hopper mounted to said frame;
ground engaging transport means supporting said frame;
a trough at the bottom of said hopper extending in the direction of travel of said wagon;
an auger having flighting received in said trough for rotation about an axis;
forward and rear hubs mounting said auger to said hopper; said front hub comprising a drive member having a plurality of drive dowels extending axially of said auger, and wherein said auger includes a tube carrying said flighting, and a plate fixed adjacent the front of said auger tube and defining bores for receiving the dowels of said drive member; said rear hub supporting said auger and mounted to a removable panel fastened to said hopper, whereby when said panel is removed, said auger may be removed through an opening covered by said panel.

12. The wagon of claim 11 wherein said rear hub includes:
an idler shaft mounted by forward and rear tapered roller bearings, said shaft being tapered at the rear;
flange mounted to said shaft and including a plurality of pins extending forwardly;
said auger tube including an apertured plate fixed adjacent the rear thereof receiving said pins of said flange.

13. The wagon of claim 12 wherein said shaft of said forward hub is mounted by forward and rear tapered roller bearings.
